(19) United States
(12) Patent Application Publication
(10) Pub. No.: US 2009/0214146 A1
(43) Pub. Date: Aug. 27, 2009

(54) SYSTEM FOR MEASURING DEFORMATIONS BY RESILIENT COMPRESSION OF A GAUGE

(75) Inventors: Pierre Ehinger, Faverges (FR); Julien Grangier, Rumilly (FR); Denis Maucout, Dingy Saint Clair (FR)

Correspondence Address: BACHMAN & LAPOINTE, P.C., 900 CHAPEL STREET, SUITE 1201, NEW HAVEN, CT, 06510, US

(73) Assignee: SNR ROULEMENTS, Annecy (FR)

(21) Appl. No.: 12/372,220

(22) Filed: Feb. 17, 2009

(30) Foreign Application Priority Data
Feb. 22, 2008 (FR) 08 00989

(51) Int. Cl. F16C 41/00; G01N 3/02

(52) U.S. Cl. 384/448; 73/856

(57) ABSTRACT

A system for measuring deformations of an area of a structural element, includes at least one gauge including a rigid substrate on the upper surface of which is arranged at least one pattern of a material capable of being deformed and delivering a signal representative of the deformations the substrate is arranged to transmit, to the pattern, the deformations of the area when the lower surface of the substrate is attached to the area. The system includes a deformable element and a device for compression of the element on the upper surface of the substrate so that the substrate can be moved by the deformations of the area. The system also includes an arrangement for attachment of the compression device on the structural element, in which the attachment arrangement is intended to ensure that the substrate is held on the area by the deformable element, which is compressed on the upper surface of the substrate.

### BACKGROUND

(1) Field of the Invention

The invention relates to a system for measuring deformations of a structural element as well as a roller bearing equipped with such a measurement system.

In particular, the invention applies to motor vehicle wheel bearings, in which the stationary ring of said bearing is intended to be secured to the chassis of the vehicle, and in which the wheel is intended to be rotatably mounted by means of the rotary ring of said bearing, and two rows of balls are provided between said rings.

(2) Prior Art

In numerous applications, in particular in support and safety systems such as ABS or ESP, it is necessary to determine the forces that are applied during movements of the vehicle at the interface between the wheel and the road on which said wheel is turning.

In particular, the determination of these forces can be performed by a measurement of the deformations of the stationary ring, which are induced by the passage of rolling bodies. Indeed, the amplitude of these deformations is representative of the forces transmitted by the bearing.

To do this, in particular document EP-1 176 409 suggests instrumenting stationary ring areas by attaching at least one gauge to them for measuring said deformations. In particular, the gauge includes a rigid substrate on the upper surface of which is arranged at least one pattern of a material capable of being deformed and delivering a signal representative of said deformations, in which the lower surface of said substrate is bonded on the area so as to transmit the deformations of said area to the pattern.

However, the implementation of the attachment of gauges by bonding presents a certain number of problems. First, it requires a preliminary preparation of the area, in particular washing, in order to remove the traces of lubricants that are used to produce the bearing. Then, the adhesive is difficult to apply, in particular with regard to the shape of the adhesive film used and the reproducibility thereof. Finally, the polymerization of the adhesive requires heating of the bearing, which, aside from its cost, can detrimentally move in particular the seals equipping the bearing.

Furthermore, the adhesive is placed at the interface between the substrate and the area, so that the transmission of the deformations is performed through it. Consequently, problems of implementation of the adhesive are more critical as the properties of the interface will directly influence the measurement of deformations. For this reason, it is necessary to calibrate the gauge after bonding of the substrate. However, aside from the complexity of implementing it, this calibration is not satisfactory since the adhesive is subject to aging, which causes its properties to vary over time.

In addition, while the variations in amplitude of the deformations to be measured are low, the deformations transmitted by the adhesive are damped and distorted. Moreover, the adhesive opposes resistance to the deformation of the area. The use of an adhesive interface therefore increases the. difficulty of using the measurements obtained.

### SUMMARY OF THE INVENTION

The invention aims to solve the problems of the prior art by proposing in particular a system for measuring deformations of an area of a structural element in which the adhesive interface is replaced by a resilient compression of the gauge.

To this end, and according to a first aspect, the invention proposes a system for measuring deformations of an area of a structural element, which system includes at least one gauge including a rigid substrate on the upper surface of which is arranged at least one pattern of a material capable of being deformed and delivering a signal representative of said deformations, in which said substrate is arranged to transmit, to the pattern, the deformations of the area when the lower surface of said substrate is attached to said area, which system includes a deformable element and a device for compression of said element on the upper surface of the substrate so that said substrate can be moved by the deformations of the area, and which system also includes means for attachment of said compression device on the structural element, in which said attachment means are intended to ensure that said substrate is held on the area by means of the deformable element, which is compressed on the upper surface of the substrate.

According to a second aspect, the invention proposes a roller bearing including a stationary member, a rotary member and at least one row of rolling bodies arranged between said members so as to enable their relative rotation, in which said stationary member includes a circumferential surface that is resiliently deformable by the forces induced by the passage of the rolling bodies when the rotary member rotates, and in which said bearing is equipped with at least one such system for measuring deformations, and the lower surface of the substrate is attached to the area, and the attachment means ensure that said substrate is held on the area by means of the deformable element, which is compressed on the upper surface of the substrate so that said substrate is moved by deformations of the area.

### BRIEF DESCRIPTION OF THE DRAWINGS

Other objectives and advantages of the invention will appear in the following description, in reference to the appended figures, in which:

FIG. 1 shows diagrammatic representations of a measurement system according to a first embodiment, respectively in a resting state (FIG. 1a) and in an essentially transverse deformation state (FIG. 1b);

FIG. 2 is an exploded perspective and partial cross-section view of a bearing equipped with a measurement system according to the first embodiment;

FIG. 3 shows diagrammatic representations of a measurement system according to a second embodiment, respectively in a resting state (FIG. 3a) and in a deformation state (FIG. 3b);

FIG. 4 is a perspective and partial cross-section view showing the implantation of the stationary ring of a bearing of a measurement system according to the second embodiment.

### DETAILED DESCRIPTION OF THE PREFERRED EMBODIMENT(S)

In relation to these figures, we will describe below a roller bearing of a motor vehicle wheel including a stationary external member 1 equipped with a flange 2 for attachment to the vehicle chassis, an internal rotary member 3 including a flange 4 on which the wheel is intended to be mounted, and two rows of balls 5 that are arranged respectively in a roller path. However, the invention can relate to other types of roller bearings, as well as to bearings for other uses in motor vehicles and the like.

When the vehicle moves, the wheel turns on the road, inducing forces at their interface, which forces are transmitted to the chassis by means of the bearing. Consequently, the determination of these forces, in particular with a view to supplying the vehicle support and safety systems, can be performed by temporally estimating the components of the torsor of forces applied on the bearing.

In particular, when the balls pass, the torsor of forces induces deformations of the stationary member 1 of which the measurement can be used to calculate the estimation of the components of said torsor. Indeed, the passage of rolling bodies 5 induces forces on the external periphery of the stationary member 1 so that at least one area 6 of said periphery is periodically resiliently deformed around an average value.

In relation to such a roller bearing, we will describe below two embodiments of a system for measuring deformations. However, a measurement system according to the invention can also be used to equip another type of mechanical member, in particular for stress transmission, so as to measure the deformations of an area of a structural element of said member.

The measurement system includes at least one gauge for measuring deformations. According to an embodiment, the gauge can include one or more patterns 7 based on resistive, in particular piezoresistive or magnetoresistive elements, which are arranged on the upper surface of a rigid support substrate 8, in which the lower surface of said substrate is attached to a resiliently deformable area 6. Thus, the substrate 8 is arranged to transmit, to the pattern 7, the deformations of the area 6, and said pattern is capable of being deformed while delivering a signal representing said deformations.

In particular, a gauge including a pattern 7 formed by a bar of material paste spaced In particular, a gauge including a bar of drops of material spaced apart on a. substrate 8 can be used to deliver a pseudo-sinusoidal time signal around an average value, which signal is dependent on the deformations of the area 6. Thus, the signal can be designed so as to use the pseudo-sinusoidal component that is representative of the amplitude of the deformations induced by the passage of rolling bodies 5.

In examples of embodiments, the patterns 7 are deposited by screen printing or electrolysis on a ceramic or Kapton substrate 8. However, the invention is not limited to a specific arrangement of the gauges for measuring deformations of the external surface of the stationary member 1.

In the embodiments shown, the measurement system includes two gauges of which the patterns 7 are respectively. deposited near the radial plane containing a row of rolling bodies 5, in which said patterns are supported by a substrate 8. Alternatively, it is possible to provide a single gauge including a single substrate 8 for supporting the two patterns 7.

In addition, the stationary member 1 includes four areas 6 that are equally distributed over its periphery, in which each of these areas can be equipped with a system for measuring deformations. Moreover, to facilitate the arrangement of the rigid substrate 8 in the areas 6, which include a flat portion.

The measurement system also includes a deformable element 9 and a device for compressing said element on the upper surface of the substrate 8. In addition, the system includes means for attaching the compression device on the. stationary member 1, in which said attachment means ensure that the substrate 8 is held on the area 6 by means of the deformable element 9, which is compressed on the upper surface of the substrate 8.

Thus, the compression force can be arranged so that the substrate 8 is moved by the deformations of the area 6, and without providing a bonding interface between said area and the lower surface of said substrate. In particular, the lower surface of the substrate 8 can be attached directly on the area 6.

In the embodiments shown, the measurement system includes a deformable element 9 for each of the substrates 8. Alternatively, a common deformable element can be provided.

In addition, to improve the transmission of deformations, the deformable element 9 can be compressed on the pattern 7 so as to increase the pressing force of said pattern on the area 6. To do this, the deformable element 9 is arranged to cover the pattern 7, as well as optionally all or part of the upper surface of the substrate 8, which is adjacent thereto. In particular, as shown in FIG. 4, the system for measuring the deformation can be arranged compactly enough to leave the electrical connection terminals 11 of the patterns 7 free.

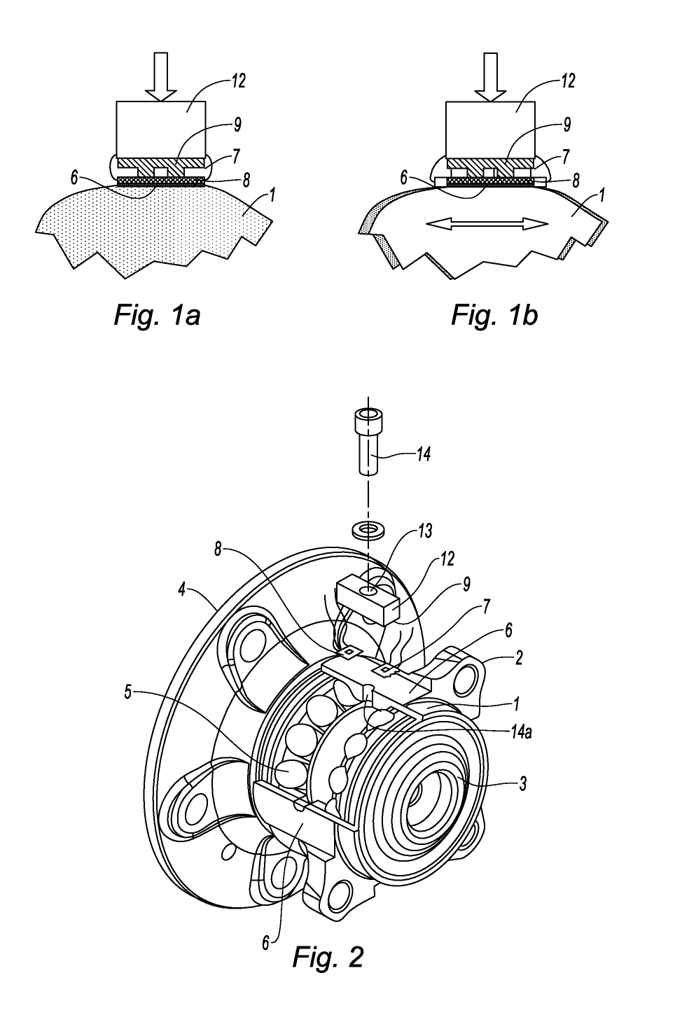

In relation to FIGS. 1 and 2, we will describe below a first embodiment of a system for measuring deformations in which the compression device integrates attachment means.

To do this, the compression device includes a flange 12 on the lower surface of which the deformable element 9 is arranged. In this embodiment, the deformable element 9 can be made of a resiliently deformable material, in particular an elastomer of low viscosity, for example with a parallelepiped shape of reduced thickness.

The compression flange 12 is common for the two deformable elements 9 which are associated, for example by bonding, on each side of the lower surface of said flange. In particular, three sides of the periphery of a deformable element 9 are flush with the edges of the flange 12, so as to enable said element to flow beyond said flange.

In addition, the flange 12 is pierced with a central hole 13 into which an attachment screw 14 is intended to be inserted. Thus, by providing a complementary threaded hole 14a in the stationary member 1, it is possible to ensure that said flange is clamped on said stationary member. In particular, the threaded hole 14a is formed between the roller paths so as not to interfere with the operation of the bearing.

In this embodiment, the clamping force has a direct impact on the pressing force exerted at the interface between the substrate 8 and the area 6 by means of the deformable. element 9. In particular, as shown in FIG. 1b, the compression force can be arranged so as to prevent, if there is a transverse deformation of the area 6, the substrate 8 from sliding over said area so as to improve the transmission of these deformations.

In this case, the transverse deformation of the element 9 makes it possible to compensate for the misalignment between the flange 12 and the area 6, in particular by enabling the movement of the pattern 7 inside said element (see FIG. 1b). In addition, the sliding can be reduced by increasing the friction coefficient between the lower surface of the substrate 8 and the area 6, in particular by a surface treatment or by adding a friction interface.

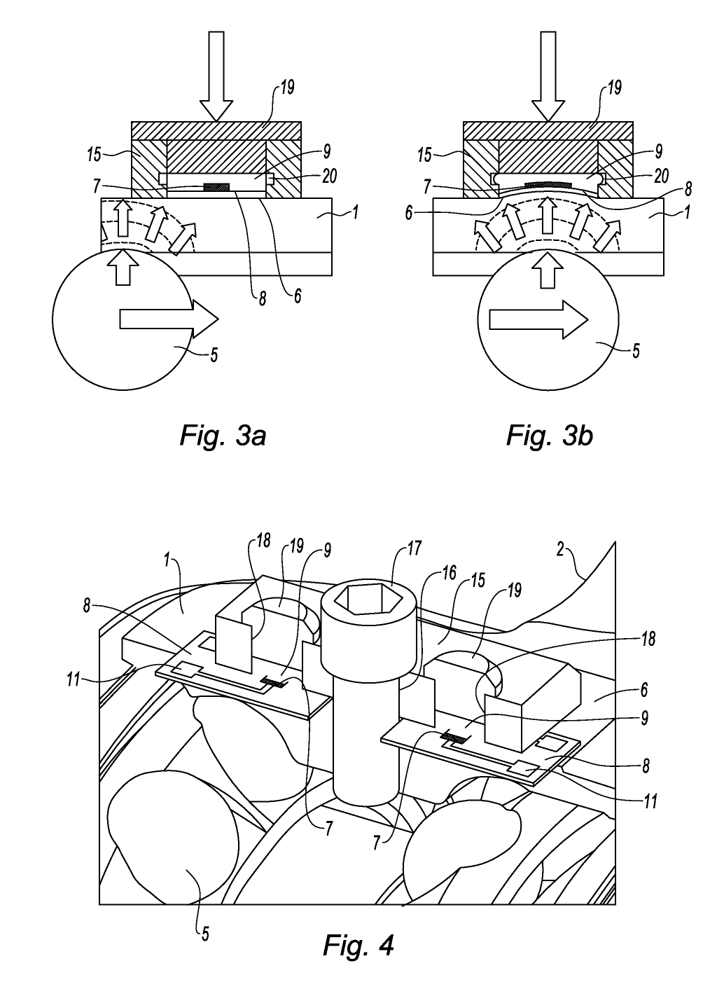

In relation to FIGS. 3 and 4, we will describe below a second embodiment of a system for measuring deformations including a module 15 in which the compression device is formed, in which said module integrates the attachment means. In this embodiment, the force of attachment of the module 15 on the stationary member 1 is therefore dissociated from the compression force exerted on the deformable element 9. In addition, the attachment of the module 15 enables a preliminary positioning of the substrate 8 both on the area 6 and with respect to said module, in which said substrate is then pressed against the area 6 by compressing the deformable element 9 on it.

In the embodiment shown, the module 15 is formed by a body equipped with a central hole 16 in which a screw for attachment 17 to the stationary member 1 is mounted. Moreover, on each side of the hole 16, the body includes two recesses 18 each opening out between an upper opening and a lower opening.

Thus, after the attachment of the module 15 by arranging a pattern 7 opposite a recess 18, a deformable element 9 is introduced into the recess 18 so as to be arranged in the lower opening. In addition, a compression device equips the upper opening so as to compress the deformable element 9 on the pattern 7. In the figures, each hole is equipped with a compression device, but a common compression device can be envisaged.

The deformable element 9 can be made of a resiliently deformable material of which the shape is arranged so as to be confined within the lower opening. The compression device can then include a cover 19 that is clamped onto said element by means of a screw so as to exert the desired compression force. Alternatively, crimping can be used.

In addition, as shown in FIG. 3, the recess 18 can include a lateral expansion reserve 20 for the deformable element 9 so as to compensate for variations in volume undergone by said element during its deformations. It is thus possible to retain the resilient properties of the deformable element 9-, in particular by controlling its flow and its stiffness.

By its confinement in the recess 18 and its optional controlled expansion, the deformable element 9 uniformly presses, in particular with respect to the gradient and the pressure, the substrate 8 on the area 6.

The result is therefore that the substrate 8 perfectly matches the planar surface of the area 6 and therefore permanently follows the deformations to be measured.

In particular, as shown in FIG. 3b, an expansion of the area 6 caused by an occasional force is transmitted to the pattern 7, which then undergoes an expansion proportional to the force applied. Then, the deformable element 9 enables the substrate 8 to return to its initial position.

In addition, the substrate 8 can slide over the area 6 so as to be moved without resistance by the deformations thereof. The result is that the pattern 7 undergoes these deformations with minimal losses, and the relevance of the signal delivered is thus improved.

As an alternative to this embodiment, the deformable element 9 can include a compressible fluid, in particular air, which is provided in the recess 18. The compression device can then include a valve that is formed in the upper opening of the recess 18 so as to exert a force pressing the substrate 8 on the area 6 by means of the compressed fluid.

1-13. (canceled)

14. A system for measuring deformations of an area of a structural element, which system includes at least one gauge including a rigid substrate on an upper surface of which is arranged at least one pattern of a material capable of being deformed and delivering a signal representative of said deformations, said substrate being arranged to transmit to the at least one pattern the deformations of the area when a lower surface of said substrate is attached to said area, a deformable element and a device for compression of said deformable element on the upper surface of the substrate so that said substrate can be moved by the deformations of the area, and means for attaching said compression device on the structural element, and said attaching means being intended to ensure that said substrate is held on the area by the deformable element, which is compressed on the upper surface of the substrate.

15. The measuring system according to claim 14, wherein the compression device integrates the attaching means.

16. The measuring system according to claim 15, wherein the compression device includes a flange on a lower face of which the deformable element is arranged, and which flange is provided with said attaching means by clamping on the structural element.

17. The measuring system according to claim 14, wherein the system includes a module in which the compression device is formed, and which module integrates the attaching means.

18. The measuring system according to claim 17, wherein the module includes at least one recess in a lower opening of which the deformable element is arranged, and an upper opening of said recess is equipped with the compression device.

19. The measuring system according to claim 18, wherein the recess includes at least one lateral expansion reserve for the deformable element.

20. The measuring system according to claim 14, wherein the deformable element is based on a resiliently deformable material.

21. The measuring system according to claim 17, wherein the deformable element includes a compressible fluid.

22. A roller bearing including a stationary member, a rotary member and at least one row of rolling bodies arranged between said stationary and rotary members so as to enable their relative rotation, said stationary member including at least one area that can be resiliently deformed by forces induced by a passage of the rolling bodies when the rotary member rotates, and at least one system for measuring deformations of said at least one area of a structural element, which system includes at least one gauge including a rigid substrate on an upper surface of which is arranged at least one pattern of a material capable of being deformed and delivering a signal representative of said deformations, said substrate being arranged to transmit to the at least one pattern the deformations of the area when a lower surface of said substrate is attached to said area, a deformable element and a device for compression of said deformable element on the upper surface of the substrate so that said substrate can be moved by the deformations of the area, and means for attaching said compression device on the structural element, and said attaching means being intended to ensure that said substrate is held on the area by the deformable element, which is compressed on the upper surface of the substrate and the lower surface of the substrate is attached on said at least one area and the attaching means ensure that said substrate is held on the at least one area by means of the deformable element, which is compressed on the upper surface of the substrate so that said substrate is moved by the deformations of the at least one area.

23. The roller bearing according to claim 22, wherein the stationary member includes complementary means for the attaching means.

24. The roller bearing according to claim 22, wherein the lower surface of the substrate is attached directly to at least one area.

25. The roller bearing according to claim 22, wherein the deformable element is compressed on the at least one pattern.

26. The roller bearing according to claim 12, further including two rows of rolling bodies, and the measurement system including two patterns of material arranged in a vicinity of a radial plane containing a row, and two deformable elements that are compressed on the patterns.
